(19) United States
(12) Patent Application Publication
(10) Pub. No.: US 2025/0354086 A1
(43) Pub. Date: Nov. 20, 2025

(54) METHOD AND PROCESS FOR MANUFACTURING A CANDLE

(71) Applicant: Cornilia Issa, Houston, TX (US)

(72) Inventor: Cornilia Issa, Houston, TX (US)

(21) Appl. No.: 18/667,642

(22) Filed: May 17, 2024

(51) Int. Cl. C11C 5/02; C11C 5/00

(52) U.S. Cl. CPC C11C 5/028; C11C 5/008

(57) ABSTRACT

A method includes performing a grinding operation on a portion of a bottom surface of a crystal to generate a flat portion on the bottom surface of the crystal. The method also includes submerging the crystal in water and drilling a hole that extends from the flat portion to a cavity within the crystal while the crystal is submerged in the water. The method also includes inserting a straw through the hole such that the straw extends through the flat portion and the cavity. The method further includes inserting a wick holder through the straw. The method also includes attaching a glass container to the flat portion such that an opening of the wick holder is inside the glass container. The method also includes inserting a wick within the wick holder.

### FIELD OF THE DISCLOSURE

The subject disclosure is generally related to manufacturing a candle.

### BACKGROUND

A candle typically has a limited lifespan based on the materials used to manufacture the candle. As a non-limiting example, a typical candle is manufactured using wax and wick. In this implementation, when the wick of the candle is ignited such that a tip of the wick is on fire, the heat from the fire initiates a process whereby the wax begins to melt. Eventually, the wax melts to a level whereby the candle can no longer function (e.g., can no longer be lit). As a result, a consumer of the candle has to throw away the candle and buy another candle. Depending on the price of the candle, it can become costly to replace candles each time the wax melts to a level whereby the candle can no longer function.

### SUMMARY

In a particular implementation, a method of manufacturing a candle includes performing a grinding operation on a portion of a bottom surface of a crystal to generate a flat portion on the bottom surface of the crystal. The method also includes submerging the crystal in water and drilling a hole that extends from the flat portion on the bottom surface of the crystal to a cavity within the crystal while the crystal is submerged in the water. The method also includes inserting a straw through the hole such that the straw extends through the flat portion on the bottom surface of the crystal and the cavity within the crystal. The method further includes inserting a wick holder through the straw. The method also includes attaching a glass container to the flat portion on the bottom surface of the crystal such that an opening of the wick holder is inside the glass container. The method also includes inserting a wick within the wick holder.

In another particular implementation, a candle is manufactured by performing a grinding operation on a portion of a bottom surface of a crystal to generate a flat portion on the bottom surface of the crystal. The candle is also manufactured by submerging the crystal in water and drilling a hole that extends from the flat portion on the bottom surface of the crystal to a cavity within the crystal while the crystal is submerged in the water. The candle is further manufactured by inserting a straw through the hole such that the straw extends through the flat portion on the bottom surface of the crystal and the cavity within the crystal. The candle is further manufactured by inserting a wick holder through the straw. The candle is further manufactured by attaching a glass container to the flat portion on the bottom surface of the crystal such that an opening of the wick holder is inside the glass container. The candle is further manufactured by inserting a wick within the wick holder.

The features, functions, and advantages described herein can be achieved independently in various implementations or can be combined in yet other implementations, further details of which can be found with reference to the following descriptions and drawings.

### BRIEF DESCRIPTION OF THE DRAWINGS

FIG. 1 is a diagram of candle that is manufactured out of a crystal in such a manner to enable continuous reuse of the candle.

FIG. 2 depicts an operation associated with manufacturing a candle out of a crystal in such a manner to enable continuous reuse of the candle.

FIG. 3 depicts another operation associated with manufacturing the candle out of the crystal in such a manner to enable continuous reuse of the candle.

FIG. 4 depicts another operation associated with manufacturing the candle out of the crystal in such a manner to enable continuous reuse of the candle.

FIG. 5 depicts an optional operation associated with manufacturing the candle out of the crystal in such a manner to enable continuous reuse of the candle.

FIG. 6 depicts another operation associated with manufacturing the candle out of the crystal in such a manner to enable continuous reuse of the candle.

FIG. 7 depicts another operation associated with manufacturing the candle out of the crystal in such a manner to enable continuous reuse of the candle.

FIG. 8 depicts another operation associated with manufacturing the candle out of the crystal in such a manner to enable continuous reuse of the candle.

FIG. 9 depicts another operation associated with manufacturing the candle out of the crystal in such a manner to enable continuous reuse of the candle.

FIG. 10 is a flowchart of an example of a method for manufacturing a candle out of a crystal in such a manner to enable continuous reuse of the candle.

FIG. 11 is a block diagram of a candle manufacturing environment including a specialized candle manufacturing device configured to support aspects of computer-implemented methods and computer-executable program instructions (or code) according to the subject disclosure.

### DETAILED DESCRIPTION

The figures and the following description illustrate specific exemplary implementations. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific implementations or examples described below, but by the claims and their equivalents.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

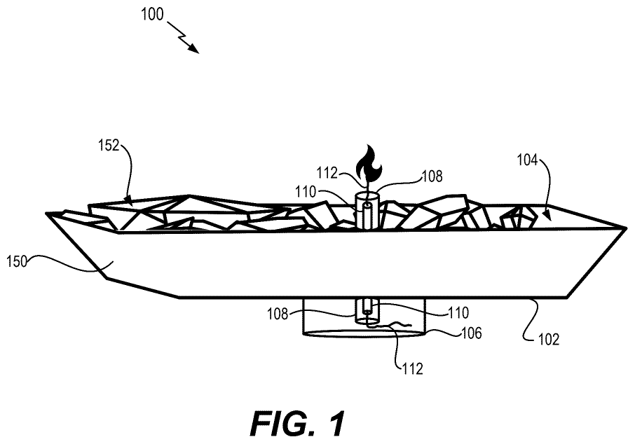

FIG. 1 depicts a diagram of candle 100 that is manufactured out of a crystal in such a manner to enable continuous reuse of the candle. For example, as illustrated in FIG. 1, a foundation of the candle 100 is comprised of a crystal 150 that includes a bottom surface 102 and a cavity 104. As depicted in FIG. 1, the cavity 104 of the crystal 150 can comprises quartz 152. It should be appreciated that the quartz 152 can typically withstand intense temperatures, such as temperatures above four-hundred (400) degrees Fahrenheit. As a result, unlike wax, using the quartz 152 in conjunction with the crystal 150 can result in a prolonged lifespan for the candle 100.

As illustrated in FIG. 1, the glass container 106 is attached to the bottom surface 102 of the crystal 150. Although depicted as a glass container 106, in other implementations, a container having different geometric properties can be attached to the bottom surface 102 of the crystal 150. As non-limiting examples, a cubical container can be attached to the bottom surface 102 of the crystal 150, a container having dimensions similar to a rectangular prism can be attached to the bottom surface 102 of the crystal 150, etc. According to one implementation, the glass container 106, or a container with different geometric properties, can be attached to the bottom surface 102 of the crystal 150 using a polyurethane adhesive. In some embodiments, the glass container 106 may have a circular shape, a square shape, a hexagonal shape, an oval shape, or a heart shape.

A straw 108 protrudes the quartz 152 within the cavity 104 of the crystal 150 and extends within the glass container 106. The straw 108 may be comprised of metal or glass. As described below, a hole can be created (e.g., drilled) that enables the straw 108 to protrude the quartz 152 and extend within the glass container 106. For example, the hole can be drilled using a three (3) millimeter drill bit to enable the straw 108 to fit within the hole. To illustrate, if the straw 108 has a diameter of six (6) millimeters, using a three (3) millimeter drill bit enables the straw 108 to have a relatively tight fit within the hole. After the hole is drilled using the 3 millimeter drill bit, the hole may be widened using a four (4) millimeter drill bit, a five (5) millimeter drill bit, and a six (6) millimeter drill bit. According to one implementation, the straw 108 is attached to the crystal 150 using a polyurethane adhesive.

As illustrated in FIG. 1, a wick holder 110 is situated (e.g., placed) within the straw 108. The wick holder 110 can be cylindrical in shape and have a diameter that is smaller than a diameter of the straw 108 to enable the wick holder 110 to fit within the straw 108. For example, if the straw 108 has a diameter of six (6) millimeters, the wick holder 110 can have a diameter of three (3) millimeters or four (4) millimeters to enable the wick holder 110 to have a relatively tight fit within the straw 108. By design, the wick holder 110 can be shorter than the straw 108 such that the wick holder 110 is completely encompassed by the straw 108. The wick holder 110 can be comprised of glass or fiberglass.

A wick 112 is inserted through the straw 108 and the wick holder 110 such that a first end of the wick 112 is inside the glass container 106 and a second end of the wick 112 protrudes the opening of the straw 108 that is proximate to the quartz 152.

The candle 100 described with respect to FIG. 1 can have a relatively long lifespan compared to a typical candle that is manufactured based on wax. For example, by using the crystal 150, the straw 108, and the wick holder 110, when the wick 112 is ignited, there is no material that will readily melt to shorten the lifespan of the candle 100. As a result, the candle 100 can have a longer lifespan than a typical candle and cost savings can be realized for a consumer.

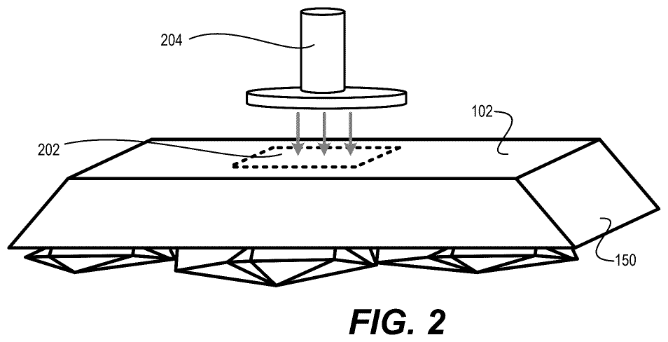

FIG. 2 depicts an operation associated with manufacturing a candle out of a crystal in such a manner to enable continuous reuse of the candle. In particular, FIG. 2 depicts a grinding operation that is utilized to prepare the bottom surface 102 of the crystal 150 during manufacture of the candle 100.

According to the illustration in FIG. 2, a grinder apparatus 204 is applied to the bottom surface 102 of the crystal 150. The grinder apparatus 204 can correspond to a grinder tool, such as an angle grinder, which can be used to cut, grind, debur, finish, or polish the bottom surface 102. According to one implementation, the grinder apparatus 204 can be a handheld grinder tool. In this implementation, a user can place the crystal 150 on a convenient surface and apply the grinder apparatus 204 to the crystal 150 to perform the grinding operation. According to another implementation, the grinder apparatus 204 can be a stationary grinder tool. In this implementation, a user can place the crystal 150 on the grinder apparatus 204 to perform the grinding operation.

As illustrated in FIG. 2, the grinding operation can be performed on the bottom surface 102 of the crystal 150 to generate a flat portion 202 on the bottom surface 102 of the crystal 150. By grinding the bottom surface 102 to create the flat portion 202 on the bottom surface 102, a relatively smooth surface area can be generated to facilitate attachment of the glass container 106, as illustrated in FIG. 1.

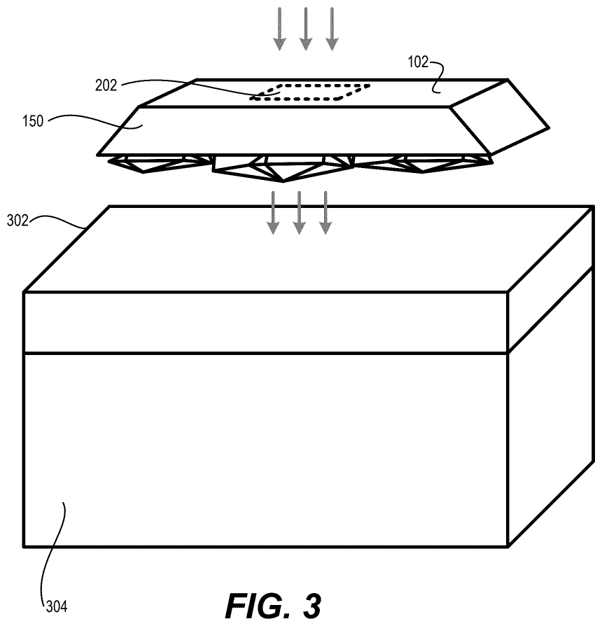

FIG. 3 depicts another operation associated with manufacturing a candle out of a crystal in such a manner to enable continuous reuse of the candle. In particular, FIG. 3 depicts submersion of the crystal 150 in water 304 during manufacture of the candle 100.

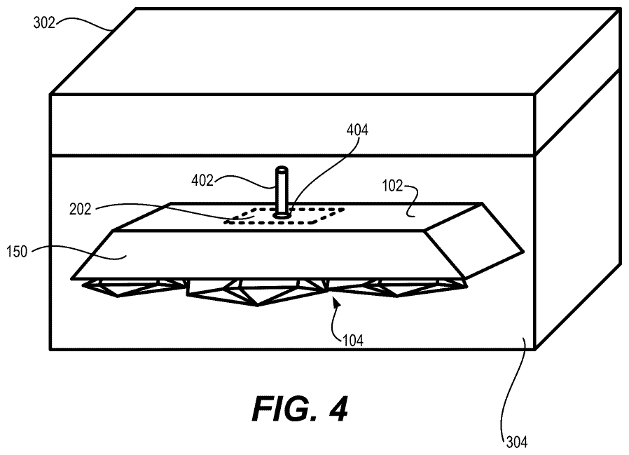

To illustrate, in FIG. 3, the crystal 150 is submerged in a tank 302 that is at least partially filled with water 304. To prevent the crystal 150 from cracking while drilling a hole through the crystal 150, as described below with respect to FIG. 4, the water 304 can be cooler than room temperature. For example, according to one implementation, the water 304 can have a temperature of 19.5 degrees Celsius to prevent the crystal 150 from cracking while drilling a hole through the crystal 150.

FIG. 4 depicts another operation associated with manufacturing a candle out of a crystal in such a manner to enable continuous reuse of the candle. In particular, FIG. 4 depicts drilling a hole 404 through the crystal 150 during manufacture of the candle 100.

To illustrate, in FIG. 4, while the crystal 150 is submerged in the water 304, a hole 404 can be drilled through the crystal 150 that extends from the flat portion 202 on the bottom surface 102 of the crystal 150 to the cavity 104 within the crystal 150. The hole 404 can be drilled using a three (3) millimeter drill bit 402 to enable the straw 108, as illustrated in FIG. 1, to fit within the hole 402. To illustrate, if the straw 108 has a diameter of six (6) millimeters, using a three (3) millimeter drill bit enables the straw 108 to have a relatively tight fit within the hole 404.

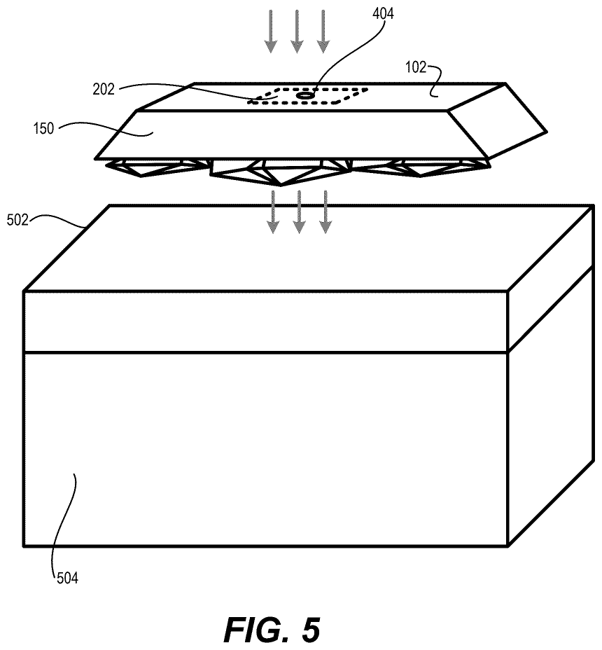

FIG. 5 depicts an optional operation associated with manufacturing a candle out of a crystal in such a manner to enable continuous reuse of the candle. In particular, FIG. 5 depicts submersion of the crystal 150 in an oxalic acid mixture 504 during manufacture of the candle 100.

To illustrate, in FIG. 5, the crystal 150 is submerged in a tank 502 that is at least partially filled with the oxalic acid mixture 504 after drilling the hole 404 in the crystal 150. The oxalic acid mixture 504 can be generated by diluting oxalic acid with water, such as the water 304. The oxalic acid mixture 504 can remove iron oxide, hematite, and calcite from the crystal 150.

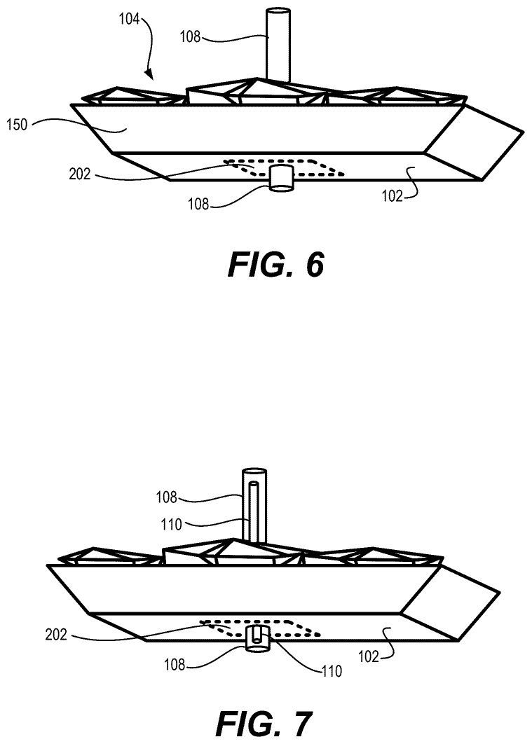

FIG. 6 depicts another operation associated with manufacturing a candle out of a crystal in such a manner to enable continuous reuse of the candle. In particular, FIG. 6 depicts insertion of the straw 108 through the crystal 150 during manufacture of the candle 100.

To illustrate, in FIG. 6, the straw 108 is inserted through the hole 404 such that the straw 108 extends through the flat portion 202 on the bottom surface 102 of the crystal 150 and the cavity 140 within the crystal 150. According to one implementation, the straw 108 can be attached to the crystal 105 using a polyurethane adhesive. As described above, if the hole 404 is created using a three (3) millimeter drill bit, selecting a straw (e.g., the straw 108) having a diameter of six (6) millimeters enables the straw 108 to have a relatively tight fit within the hole 404.

FIG. 7 depicts another operation associated with manufacturing a candle out of a crystal in such a manner to enable continuous reuse of the candle. In particular, FIG. 7 depicts insertion of the wick holder 110 through the straw 108 during manufacture of the candle 100. To illustrate, in FIG. 7, the wick holder 110 is inserted through the straw 108. According to one implementation, the wick holder 110 is comprised of glass. According to another implementation, the wick holder 110 is comprised of fiberglass.

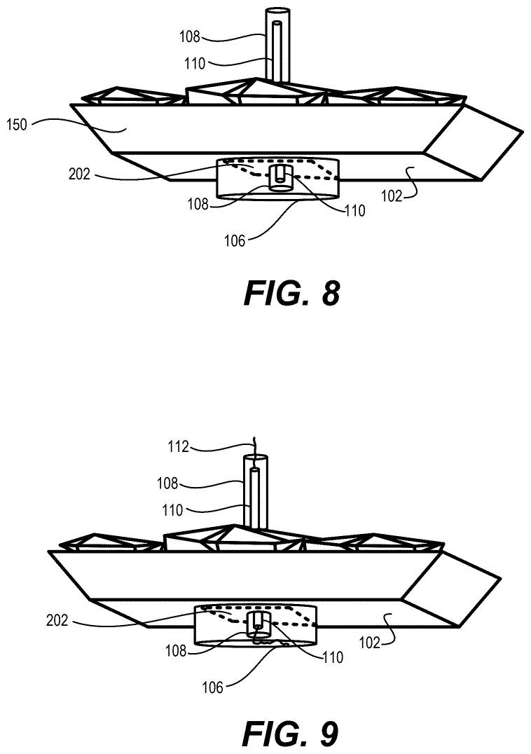

FIG. 8 depicts another operation associated with manufacturing a candle out of a crystal in such a manner to enable continuous reuse of the candle. In particular, FIG. 7 depicts the attachment of the glass container 106 to crystal 150 during manufacture of the candle 100.

To illustrate, in FIG. 8, the glass container 106 is attached to the flat portion 202 on the bottom surface 102 of the crystal 150 such that an opening of the wick holder 110 is inside the glass container 106. According to one implementation, the glass container 106 is attached to the flat portion 202 on the bottom surface 102 of the crystal 150 using a polyurethane adhesive.

FIG. 9 depicts another operation associated with manufacturing a candle out of a crystal in such a manner to enable continuous reuse of the candle. In particular, FIG. 7 depicts insertion of the wick 112 within the wick holder 110 during manufacture of the candle 100.

The techniques described with respect to FIGS. 2-9 can result in the manufacture of the candle 100 having a relatively long lifespan compared to a typical candle that is manufactured based on wax. For example, by using the crystal 150, the straw 108, and the wick holder 110, when the wick 112 is ignited, there is no material that will readily melt to shorten the lifespan of the candle 100. As a result, the candle 100 can have a longer lifespan than a typical candle and cost savings can be realized for a consumer.

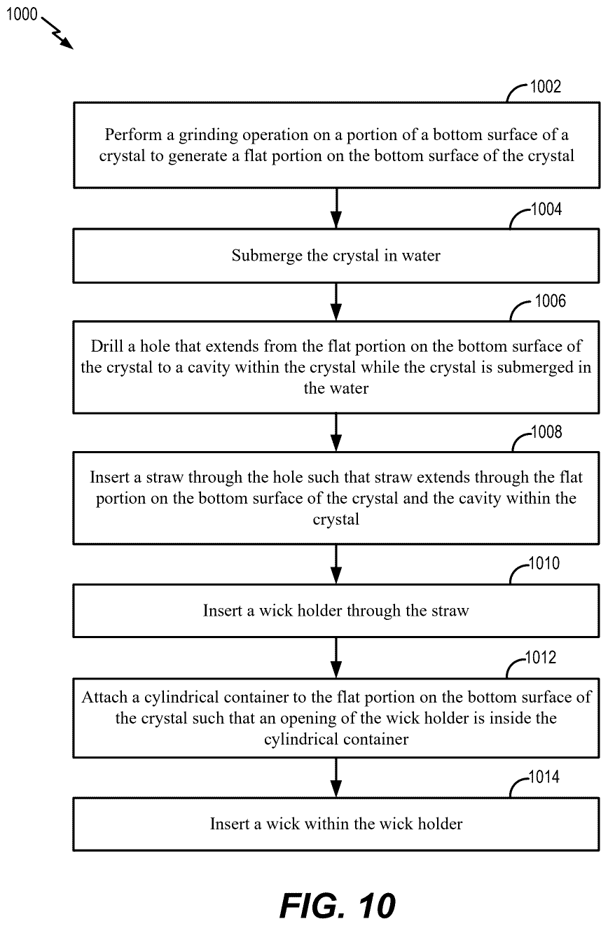

Referring to FIG. 10, a method 1000 for manufacturing a candle out of a crystal in such a manner to enable continuous reuse of the candle. In a particular aspect, one or more operations of the method 1000 are performed using an automated process. For example, each operation, or one or more operations, of the method 1000 can be performed by programming one or more machines to operate based on a set of commands (e.g., specialized instructions executed by processors for dedicated candle-making equipment).

The method 1000 includes performing a grinding operation on a portion of a bottom surface of a crystal to generate a flat portion on the bottom surface of the crystal, at block 1002. For example, referring to FIG. 2, the grinder apparatus 204 can perform the grinding operation on the bottom surface 102 of the crystal 150 to generate a flat portion 202 on the bottom surface 102 of the crystal 150. By grinding the bottom surface 102 to create the flat portion 202 on the bottom surface 102, a relatively smooth surface area can be generated to facilitate attachment of the glass container 106, as illustrated in FIG. 1.

The method 1000 also includes submerging the crystal in water, at block 1004. For example, referring to FIG. 3, the crystal 150 is submerged in a tank 302 that is at least partially filled with water 304. To prevent the crystal 150 from cracking while drilling the hole 404 through the crystal 150, the water 304 can be cooler than room temperature.

The method 1000 also includes drilling a hole that extends from the flat portion on the bottom surface of the crystal to a cavity within the crystal while the crystal is submerged in the water, at block 1006. For example, referring to FIG. 4, while the crystal 150 is submerged in the water 304, the hole 404 can be drilled through the crystal 150 that extends from the flat portion 202 on the bottom surface 102 of the crystal 150 to the cavity 104 within the crystal 150

The method 1000 can optionally include submerging the crystal in an oxalic acid mixture after drilling the hole. For example, referring to FIG. 5, the crystal 150 is submerged in a tank 502 that is at least partially filled with the oxalic acid mixture 504 after drilling the hole 404 in the crystal 150. The oxalic acid mixture 504 can be generated by diluting oxalic acid with water, such as the water 304. The oxalic acid mixture 504 can remove iron oxide, hematite, and calcite from the crystal 150.

The method 1000 also includes inserting a straw through the hole such that the straw extends through the flat portion on the bottom surface of the crystal and the cavity within the crystal, at block 1008. For example, referring to FIG. 6, the straw 108 is inserted through the hole 404 such that the straw 108 extends through the flat portion 202 on the bottom surface 102 of the crystal 150 and the cavity 140 within the crystal 150. According to one implementation, the straw 108 can be attached to the crystal 105 using a polyurethane adhesive.

The method 1000 also includes inserting a wick holder through the straw, at block 1010. For example, referring to FIG. 7, the wick holder 110 is inserted through the straw 108. According to one implementation, the wick holder 110 is comprised of glass. According to another implementation, the wick holder 110 is comprised of fiberglass.

The method 1000 also includes attaching a glass container to the flat portion on the bottom surface of the crystal such that an opening of the wick holder is inside the glass container, at block 1012. For example, referring to FIG. 8, the glass container 106 is attached to the flat portion 202 on the bottom surface 102 of the crystal 150 such that an opening of the wick holder 110 is inside the glass container 106. According to one implementation, the glass container 106 is attached to the flat portion 202 on the bottom surface 102 of the crystal 150 using a polyurethane adhesive.

The method 1000 also includes inserting a wick within the wick holder, at block 1014. For example, referring to FIG. 9, the wick 112 is inserted within the wick holder 110.

The method 1000 can result in the manufacture of the candle 100 having a relatively long lifespan compared to a typical candle that is manufactured based on wax. For example, by using the crystal 150, the straw 108, and the wick holder 110, when the wick 112 is ignited, there is no material that will readily melt to shorten the lifespan of the candle 100. As a result, the candle 100 can have a longer lifespan than a typical candle and cost savings can be realized for a consumer.

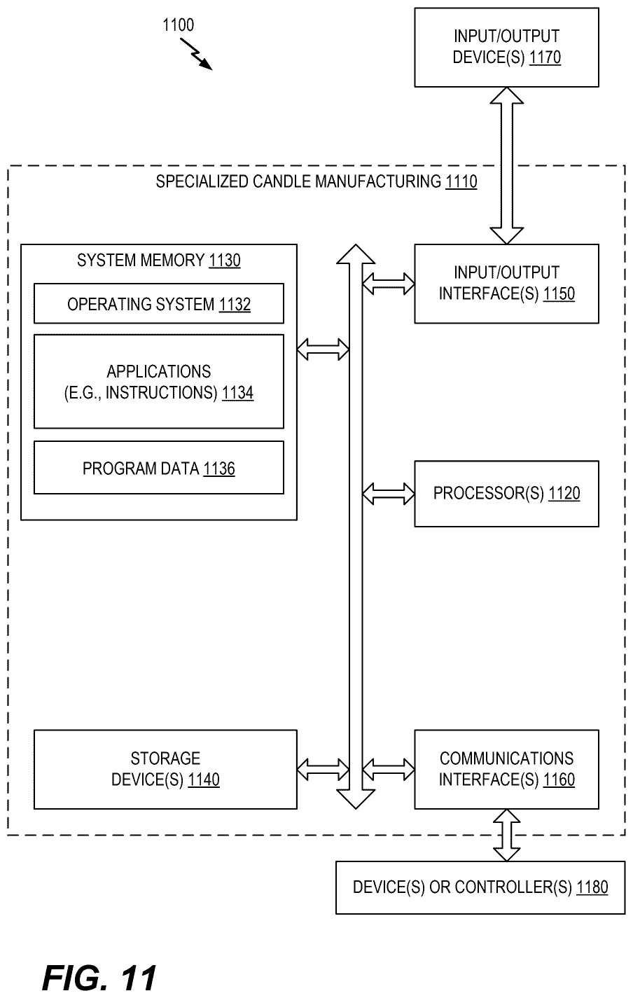

FIG. 11 is a block diagram of a candle manufacturing environment 1100 including a specialized candle manufacturing device 1110 configured to support aspects of computer-implemented methods and computer-executable program instructions (or code) according to the subject disclosure. For example, the specialized candle manufacturing device 1110, or portions thereof, is configured to execute instructions to initiate, perform, or control one or more operations described with reference to FIGS. 1-10. According to another implementation, the specialized candle manufacturing device 1110 can correspond a plurality of devices, such as a specialty grinding apparatus, a specialty drill, etc.

The specialized candle manufacturing device 1110 includes one or more processors 1120. The processor(s) 1120 are configured to communicate with system memory 1130, one or more storage devices 1140, one or more input/output interfaces 1150, one or more communications interfaces 1160, or any combination thereof. The system memory 1130 includes volatile memory devices (e.g., random access memory (RAM) devices), nonvolatile memory devices (e.g., read-only memory (ROM) devices, programmable read-only memory, and flash memory), or both. The system memory 1130 stores an operating system 1132, which can include a basic input/output system for booting the specialized candle manufacturing device 1110 as well as a full operating system to enable the specialized candle manufacturing device 1110 to interact with users, other programs, and other devices. According to an implementation, the system memory 1130 stores system (program) data 1136.

The system memory 1130 includes one or more applications 1134 (e.g., sets of instructions or commands) executable by the processor(s) 1120. As an example, the one or more applications 1134 include instructions executable by the processor(s) 1120 to initiate, control, or perform one or more operations described with reference to FIGS. 1-10.

In a particular implementation, the system memory 1130 includes a non-transitory, computer readable medium (e.g., a computer-readable storage device) storing the instructions that, when executed by the processor(s) 1120, cause the processor(s) 1120 to initiate, perform, or control operations to manufacture the candle 100. The operations can correspond to the operations described in the method 1000 of FIG. 10.

The one or more storage devices 1140 include nonvolatile storage devices, such as magnetic disks, optical disks, or flash (e.g. solid state) memory devices. In a particular example, the storage devices 1140 include both removable and non-removable memory devices. The storage devices 1140 are configured to store an operating system, images of operating systems, applications (e.g., one or more of the applications 1134), and program data (e.g., the program data 1136). In a particular aspect, the system memory 1130, the storage devices 1140, or both, include tangible computer-readable media. In a particular aspect, one or more of the storage devices 1140 are external to the specialized candle manufacturing device 1110.

The one or more input/output interfaces 1150 enable the specialized candle manufacturing device 1110 to communicate with one or more input/output devices 1170 to facilitate user interaction. For example, the one or more input/output interfaces 1150 can include a display interface, an input interface, or both. For example, the input/output interface 1150 is adapted to receive input from a user, to receive input from another computing device, or a combination thereof. In some implementations, the input/output interface 1150 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey).

In some implementations, a non-transitory, computer readable medium stores instructions that, when executed by one or more processors 1120, cause the one or more processors 1120 to initiate, perform, or control operations to perform part or all of the functionality described above. For example, the instructions can be executable to implement one or more of the operations or methods of FIGS. 1-10. In some implementations, part or all of one or more of the operations or methods of FIGS. 1-10 can be implemented by one or more processors (e.g., one or more central processing units (CPUs), one or more graphics processing units (GPUs), one or more digital signal processors (DSPs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations can be apparent to those of skill in the art upon reviewing the disclosure. Other implementations can be utilized and derived from the disclosure, such that structural and logical substitutions and changes can be made without departing from the scope of the disclosure. For example, method operations can be performed in a different order than shown in the figures or one or more method operations can be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results can be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Further, the disclosure comprises embodiments according to the following examples:

### Example 1

A method of manufacturing a candle, the comprising: performing a grinding operation on a portion of a bottom surface of a crystal to generate a flat portion on the bottom surface of the crystal; submerging the crystal in water; drilling a hole that extends from the flat portion on the bottom surface of the crystal to a cavity within the crystal while the crystal is submerged in the water; inserting a straw through the hole such that the straw extends through the flat portion on the bottom surface of the crystal and the cavity within the crystal; inserting a wick holder through the straw; attaching a glass container to the flat portion on the bottom surface of the crystal such that an opening of the wick holder is inside the glass container; and inserting a wick within the wick holder.

### Example 2

The method of Example 1, wherein the cavity within the crystal comprises quartz.

### Example 3

The method of Example 1 or 2, wherein the water is cooler than room temperature to prevent the crystal from cracking while drilling the hole.

### Example 4

The device of any of Examples 1 to 3, wherein the water has a temperature of 19.5 degrees Celsius to prevent the crystal from cracking while drilling the hole.

### Example 5

The method of any of Examples 1 to 4, wherein the hole is drilled using a 3 millimeter drill bit, and wherein, after the hole is drilled using the 3 millimeter drill bit, the hole is widened using a 4 millimeter drill bit, a 5 millimeter drill bit, and a 6 millimeter drill bit.

### Example 6

The method of any of Examples 1 to 5, wherein the wick holder is comprised of glass or fiberglass.

### Example 7

The device of any of Examples 1 to 6, further comprising diluting oxalic acid with water to generate an oxalic acid mixture.

### Example 8

The method of any of Examples 1 to 7, wherein the glass container is attached to the flat portion on the bottom surface of the crystal using a polyurethane adhesive.

### Example 9

The method of any of Examples 1 to 8, wherein the straw is attached to the crystal using a polyurethane adhesive.

### Example 10

The method of any of Examples 1 to 9, wherein the straw has a diameter of six millimeters.

### Example 11

A candle, the candle manufactured by: performing a grinding operation on a portion of a bottom surface of a crystal to generate a flat portion on the bottom surface of the crystal; submerging the crystal in water; drilling a hole that extends from the flat portion on the bottom surface of the crystal to a cavity within the crystal while the crystal is submerged in the water; inserting a straw through the hole such that the straw extends through the flat portion on the bottom surface of the crystal and the cavity within the crystal; inserting a wick holder through the straw; attaching a glass container to the flat portion on the bottom surface of the crystal such that an opening of the wick holder is inside the glass container; and inserting a wick within the wick holder.

### Example 12

The candle of Example 11, wherein the cavity within the crystal comprises quartz.

### Example 13

The candle of Example 11 or 12, wherein the water is cooler than room temperature to prevent the crystal from cracking while drilling the hole.

### Example 14

The candle of any of Examples 11 to 13, wherein the water has a temperature of 19.5 degrees Celsius to prevent the crystal from cracking while drilling the hole.

### Example 15

The candle of any of Examples 11 to 14, wherein the hole is drilled using a 3 millimeter drill bit.

### Example 16

The candle of any of Examples 11 to 15, wherein the wick holder is comprised of glass or fiberglass.

### Example 17

The candle of any of Examples 11 to 16, wherein the candle is further manufactured by diluting oxalic acid with water to generate an oxalic acid mixture.

### Example 18

The candle of any of Examples 11 to 17, wherein the glass container is attached to the flat portion on the bottom surface of the crystal using a polyurethane adhesive.

### Example 19

The candle of any of Examples 11 to 18, wherein the straw is attached to the crystal using a polyurethane adhesive.

### Example 20

The candle of any of Examples 11 to 19, wherein the straw has a diameter of six millimeters.

What is claimed is:

1. A method of manufacturing a candle, the comprising:
performing a grinding operation on a portion of a bottom surface of a crystal to generate a flat portion on the bottom surface of the crystal;
submerging the crystal in water;
drilling a hole that extends from the flat portion on the bottom surface of the crystal to a cavity within the crystal while the crystal is submerged in the water;
inserting a straw through the hole such that the straw extends through the flat portion on the bottom surface of the crystal and the cavity within the crystal, wherein the straw is comprised of metal or glass;
inserting a wick holder through the straw;
attaching a glass container to the flat portion on the bottom surface of the crystal such that an opening of the wick holder is inside the glass container; and
inserting a wick within the wick holder.

2. The method of claim 1, wherein the cavity within the crystal comprises quartz.

3. The method of claim 1, wherein the water is cooler than room temperature to prevent the crystal from cracking while drilling the hole.

4. The method of claim 1, wherein the water has a temperature of 19.5 degrees Celsius to prevent the crystal from cracking while drilling the hole.

5. The method of claim 1, wherein the hole is drilled using a 3 millimeter drill bit.

6. The method of claim 5, wherein, after the hole is drilled using the 3 millimeter drill bit, the hole is widened using a 4 millimeter drill bit, a 5 millimeter drill bit, and a 6 millimeter drill bit.

7. The method of claim 1, wherein the wick holder is comprised of glass or fiberglass.

8. The method of claim 1, wherein the glass container has a circular shape, a square shape, a hexagonal shape, an oval shape, or a heart shape.

9. The method of claim 1, wherein the glass container is attached to the flat portion on the bottom surface of the crystal using a polyurethane adhesive.

10. The method of claim 1, wherein the straw is attached to the crystal using a polyurethane adhesive.

11. The method of claim 1, wherein the straw has a diameter of six millimeters.

12. A candle, the candle manufactured by:
performing a grinding operation on a portion of a bottom surface of a crystal to generate a flat portion on the bottom surface of the crystal;
submerging the crystal in water;
drilling a hole that extends from the flat portion on the bottom surface of the crystal to a cavity within the crystal while the crystal is submerged in the water;
inserting a straw through the hole such that the straw extends through the flat portion on the bottom surface of the crystal and the cavity within the crystal, wherein the straw is comprised of metal or glass;
inserting a wick holder through the straw;
attaching a glass container to the flat portion on the bottom surface of the crystal such that an opening of the wick holder is inside the glass container; and
inserting a wick within the wick holder.

13. The candle of claim 12, wherein the cavity within the crystal comprises quartz.

14. The candle of claim 12, wherein the water is cooler than room temperature to prevent the crystal from cracking while drilling the hole.

15. The candle of claim 12, wherein the water has a temperature of 19.5 degrees Celsius to prevent the crystal from cracking while drilling the hole.

16. The candle of claim 12, wherein the hole is drilled using a 3 millimeter drill bit, and wherein, after the hole is drilled using the 3 millimeter drill bit, the hole is widened using a 4 millimeter drill bit, a 5 millimeter drill bit, and a 6 millimeter drill bit.

17. The candle of claim 12, wherein the wick holder is comprised of glass or fiberglass.

18. The candle of claim 12, wherein the glass container is attached to the flat portion on the bottom surface of the crystal using a polyurethane adhesive.

19. The candle of claim 12, wherein the straw is attached to the crystal using a polyurethane adhesive.

20. The candle of claim 12, wherein the glass container has a circular shape, a square shape, a hexagonal shape, an oval shape, or a heart shape.
